(19) United States
(12) Patent Application Publication
(10) Pub. No.: US 2013/0106918 A1
(43) Pub. Date: May 2, 2013

(54) MULTILAYER LIGHT GUIDE ASSEMBLY

(71) Applicants: Ion Bita, San Jose, CA (US); Gang Xu, Cupertino, CA (US); Marek Mienko, San Jose, CA (US); Russell Wayne Gruhlke, Milpitas, CA (US)

(72) Inventors: Ion Bita, San Jose, CA (US); Gang Xu, Cupertino, CA (US); Marek Mienko, San Jose, CA (US); Russell Wayne Gruhlke, Milpitas, CA (US)

(73) Assignee: QUALCOMM MEMS Technologies, Inc., San Diego, CA (US)

(21) Appl. No.: 13/287,426

(22) Filed: Nov. 2, 2011

(51) Int. Cl. G09G 5/10; F21V 8/00; F21V 7/04; G02B 26/00

(52) U.S. Cl. 345/690; 359/290; 362/615; 362/606; 362/607

(57) ABSTRACT

This disclosure provides systems, methods, and apparatus for providing illumination using a light-turning stack having diffractive light-turning features to eject light out of the light-turning stack. In one aspect, light ejected from the light-turning stack may be applied to illuminate a display. The light-turning stack includes a light-guiding layer having a surface on which the diffractive light-turning features are disposed. A planarization layer having a refractive index different than a refractive index of the light-guiding layer directly contacts the diffractive light-turning features and has a planar surface opposite the light-turning features. The light-guiding layer can also have a planar surface opposite the light-turning features. Both these planar surfaces, on opposite sides of the light turning stack, facilitate the integration of the light-guiding layer with other layers of material, including functional layers.

### TECHNICAL FIELD

This disclosure relates to optical devices, including illumination devices with light guide assemblies having diffractive light-turning features, and to electromechanical systems.

### DESCRIPTION OF THE RELATED TECHNOLOGY

Electromechanical systems (EMS) include devices having electrical and mechanical elements, actuators, transducers, sensors, optical components (e.g., minors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a metallic membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Reflected ambient light is used to form images in some display devices, such as those using pixels formed by interferometric modulators. The perceived brightness of these displays depends upon the amount of light that is reflected towards a viewer. In low ambient light conditions, light from an artificial light source is used to illuminate the reflective pixels, which then reflect the light towards a viewer to generate an image. To meet market demands and design criteria, new illumination devices are continually being developed to meet the needs of display devices, including reflective and transmissive displays.

### SUMMARY

The systems, methods and devices of the disclosure each have several innovative aspects, no single one of which is solely responsible for the desirable attributes disclosed herein.

One innovative aspect of the subject matter described in this disclosure can be implemented in an optical system. The optical system includes a first material having a low index of refraction that is greater than the index of refraction of air. The optical system also has a second material having a high index of refraction greater than the low index of refraction. An interface is disposed between the first material and the second material; and diffractive light-turning features are formed at the interface. The first and second materials can form a light-turning stack having planar major surfaces that allow the attachment of other layers. For example, functional layers can be attached to one or both of the major surfaces. The functional layers can include an antiglare layer, a scratch resistant layer, an antifingerprint layer, a touch panel, an optical filtering layer, a light diffusion layer, and combinations thereof.

In some implementations, the second material can form a light-guiding layer. A light source can be disposed at an edge of the light-guiding layer and the diffractive light-turning features can be used to redirect light out of the light-guiding layer to illuminate a display. The display can be a reflective display, such as an interferometric modulator display.

In another innovative aspect, an illumination system includes a means for turning light that includes a means for guiding light, a means for providing a planar surface formed on the means for guiding light, and a means for diffractively ejecting light out of the means for guiding light. The means for providing the planar surface includes a material having a different refractive index than the means for guiding light. The means for diffractively ejecting light is formed at an interface of the means for guiding light and the means for providing a planar surface.

In yet another innovative aspect, a method for manufacturing an illumination system is provided. The method includes providing a light-guiding layer; providing a second layer; and providing diffractive light-turning features at an interface of the light-guiding layer and the second layer. The second layer has a refractive index that is greater than air and that is different from a refractive index of the light-guiding layer. The light-guiding layer and the second layer directly contact each other at the interface.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A shows an example of a cross-section of a light-turning stack that can be used in an optical device, such as an illumination device.

FIG. 9B shows an example of a cross-section of a light-turning stack that can be used in an optical device in which the layers of FIG. 9A are flipped.

FIG. 9C shows another example of a cross-section of a light-turning stack that can be used in an optical device.

FIG. 10A shows an example of a cross-section of an illumination system for illuminating a display.

FIG. 10B shows an example of a cross-section of an illumination system in which the layers of the light-turning stack of FIG. 10A are flipped.

FIG. 11 shows an example of a cross-section of an illumination system having multiple layers formed contacting and directly below or over a light-turning stack.

FIG. 12 shows an example of a cross-section of an illumination system in which the layers of the light-turning stack of FIG. 11 are flipped.

FIG. 13 is a block diagram depicting an example of a method of manufacturing such an illumination system.

FIGS. 14A and 14B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, parking meters, washers, dryers, washer/dryers, parking meters, packaging (e.g., electromechanical systems (EMS), MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to one having ordinary skill in the art.

In some implementations, a light-turning stack is provided for use in an optical system. The light-turning stack includes a light-guiding layer for propagating light within that layer. The light-guiding layer can have a flat major surface and an opposing surface having contours that form diffractive light-turning features. The light-turning stack also includes a planarization layer in direct contact with the contoured surface. The planarization layer has a lower refractive index than the light guide and has a flat surface opposite the contoured surface. The flat surfaces on either major surface of the light-turning stack facilitate the attachment of other structures, such as functional layers or a display, to the light guide.

The optical system may be an illumination system in some implementations. The diffractive light-turning features of the light-turning stack can be configured to turn light propagating within the light-guide so that the light is ejected out of the light guide and towards a display, thereby illuminating a display. In some implementations, the ejected light can impinge on display elements of the display and continue to a viewer, thereby generating a viewable image.

Particular implementations of the subject matter described in this disclosure can be implemented to realize one or more of the following potential advantages. For example, the planarization layer and light-guiding layer may provide planar surfaces on opposite sides of a contoured interface formed by contacting surfaces of both the light guide layer and the planarization layer. These planar surfaces facilitate the integration and attachment of additional layers with the light-guiding layer. For example, additional functional layers can be stacked to provide various functions and can include, for example, an antiglare layer, a scratch resistant layer, an antifingerprint layer, a touch panel, an optical filtering layer, a light diffusion layer, and combinations thereof. Furthermore, the contoured interface between the planarization layer and the light-guiding layer can provide diffractive light-turning features. Both layers can be made of materials having an index of refraction greater than air and the refractive index of both materials can affect the diffraction and/or light ejection characteristics of the diffractive light-turning features. For example, diffractive light-turning features imbedded in a stack of layers can result in a lower loss of incident ambient light than diffractive light-turning features that are formed at an interface with air, since less incident ambient light is specularly reflected out of the light turning stack, for example, to a viewer. This lower light loss can increase image contrast, while also providing greater image brightness in some implementations, such as for reflective displays, since more light illuminates the display when less incident ambient light is reflected.

One example of a suitable MEMS or electromechanical systems (EMS) device, to which the described methods and implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

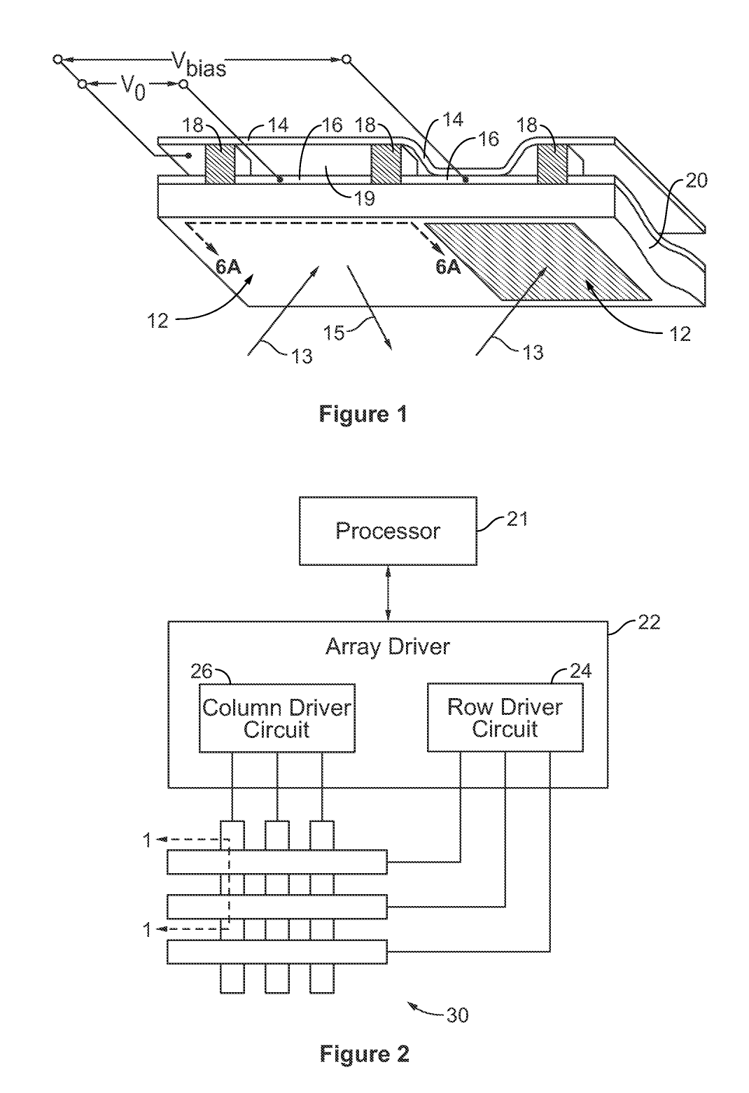

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 can be approximately 1-1000 um, while the gap 19 can be less than <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

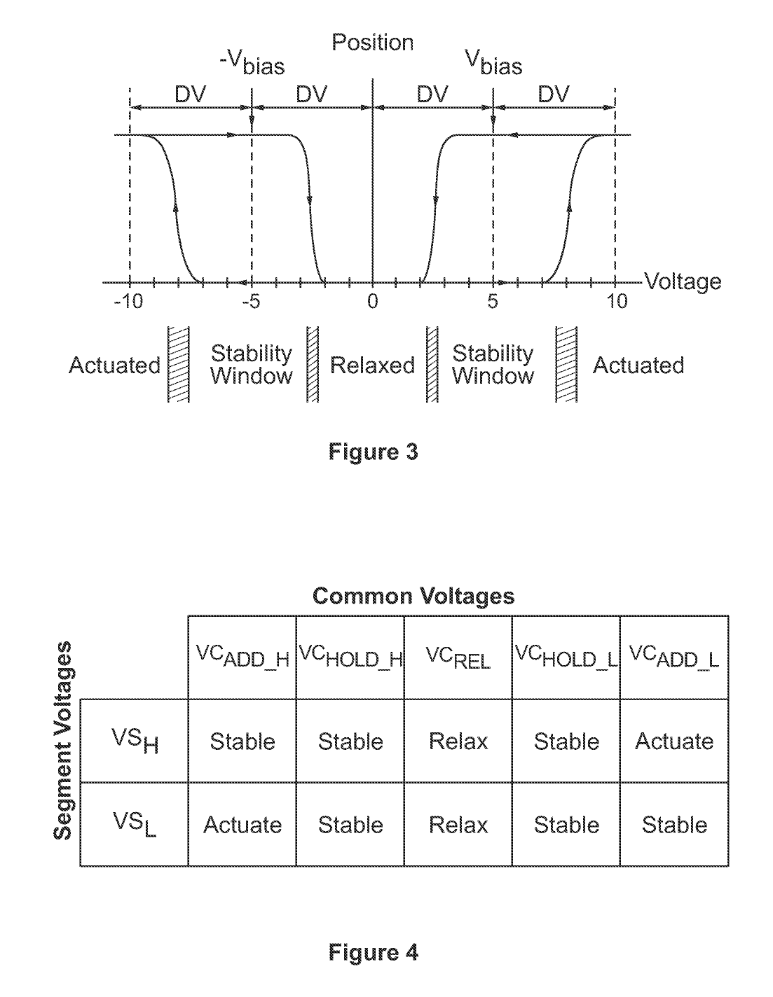

FIG. 3 shows an example of a diagram illustrating a movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, for example, about a 10-volt potential difference to cause the movable reflective layer, or minor, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3 to 7 volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels are exposed to a steady state or bias voltage difference of approximately, in this example, 5 volts such that they remain in the previous strobing state. In this example, after being addressed, each pixel sees a potential difference within the “stability window” of about 3-7 volts. This hysteresis property feature enables the pixel design, such as the one illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

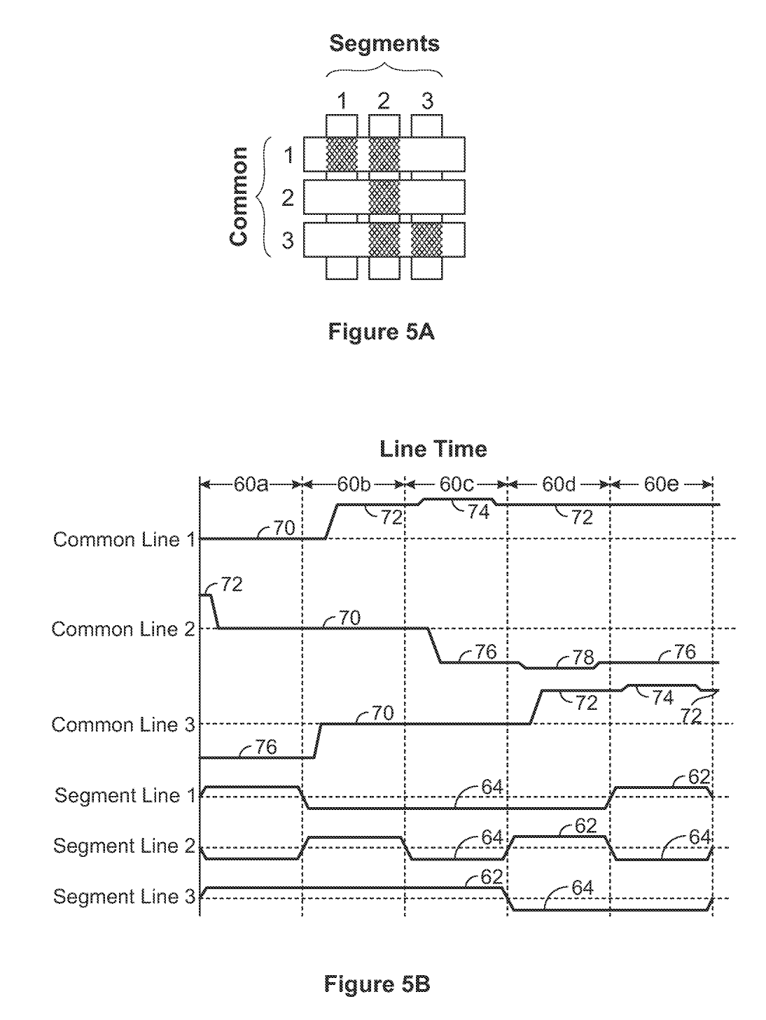

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{—}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, for example, 3×3 array of FIG. 2, which will ultimately result in the line time 60e display arrangement illustrated in FIG. 5B. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

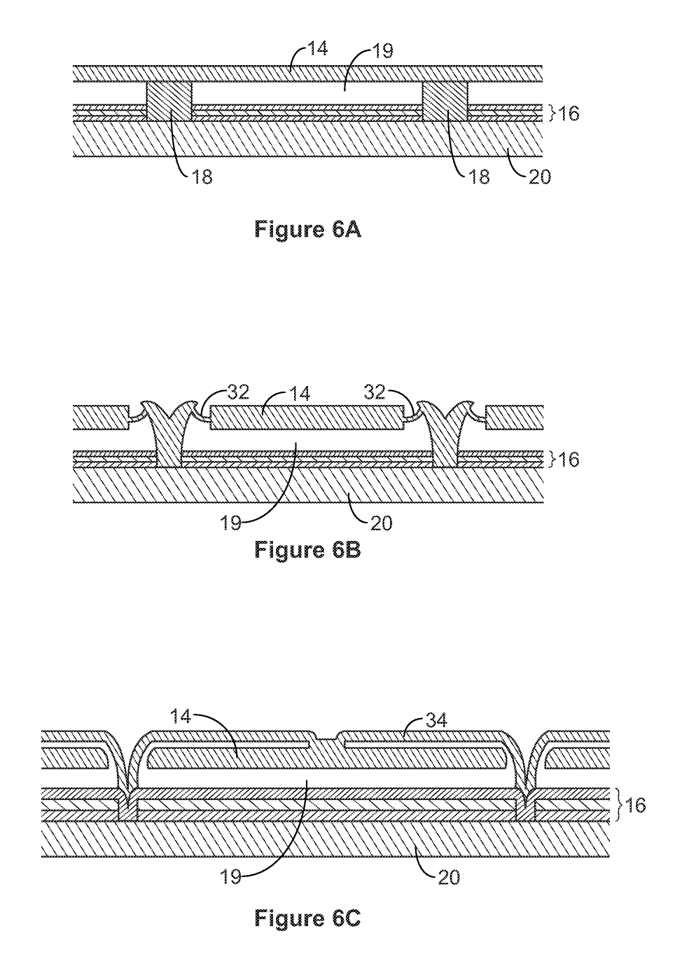

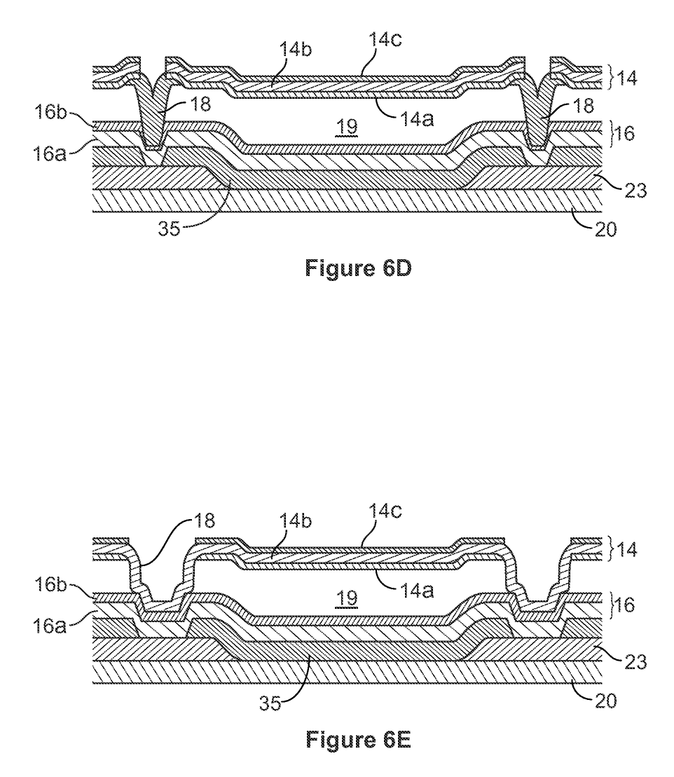

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BC1₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as patterning.

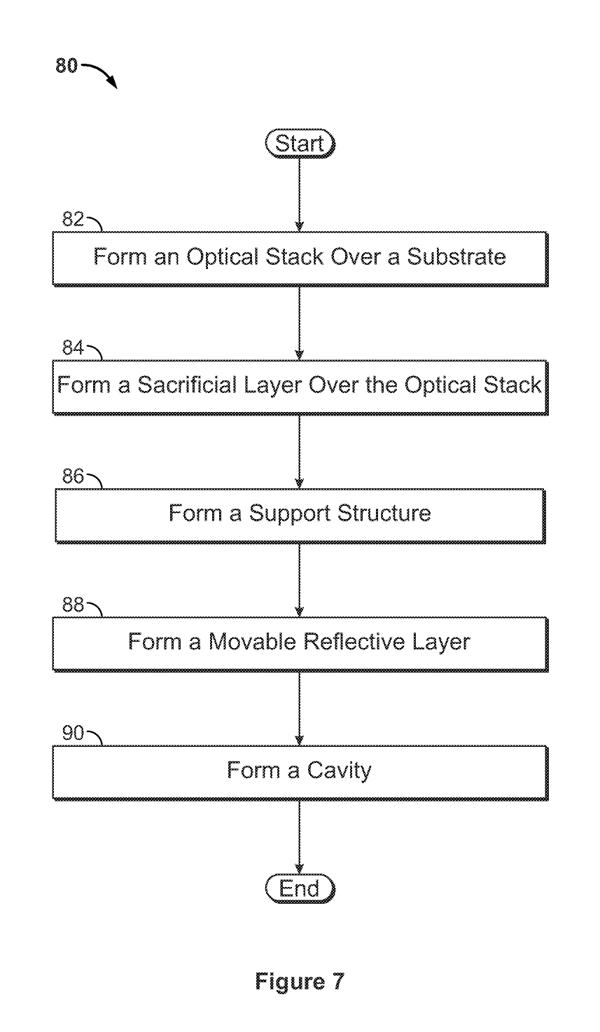

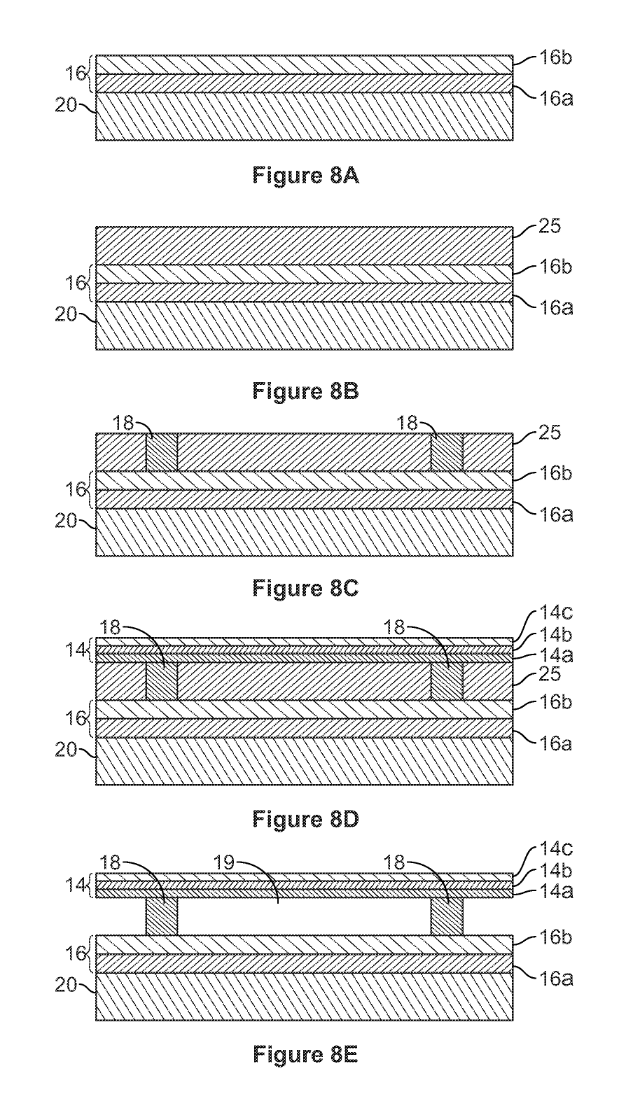

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 also may be referred to herein as an ^{“}unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

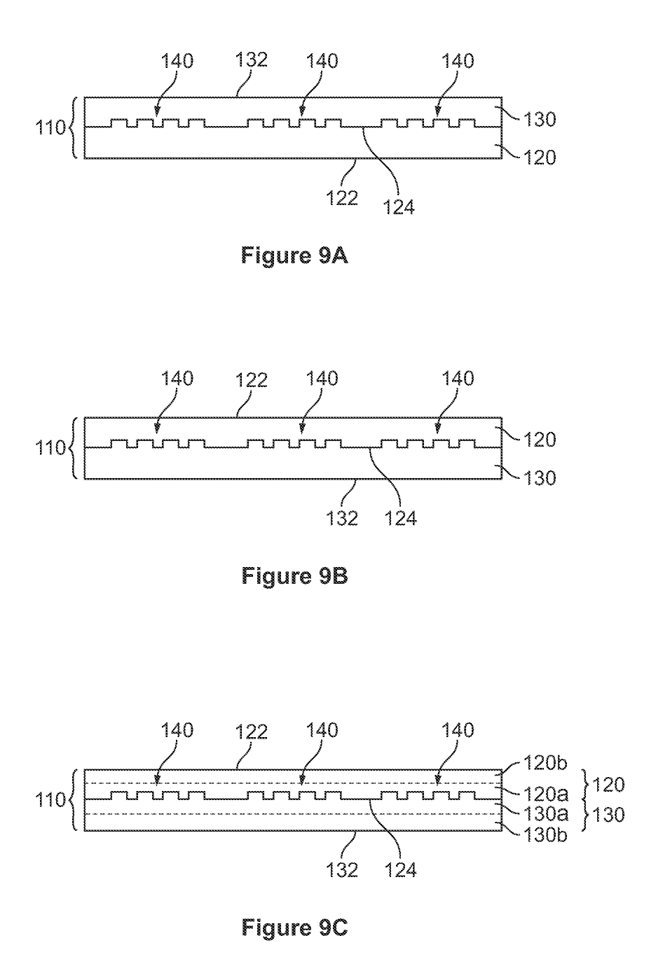

FIG. 9A shows an example of a cross-section of a light-turning stack 110 that can be used in an optical device, such as an illumination device. The light-turning stack 110 includes a light-guiding layer 120 and a planarization layer 130. The light-guiding layer 120 has a higher refractive index than the planarization layer 130 and serves as a light guide. In some implementations, light can propagate within the light-guiding layer 120 by total internal reflection off of surfaces of that layer. The light-guiding layer 120 has a first major surface 122. On an opposite side from the first major surface 122, the light-guiding layer 120 and the planarization layer 130 directly contact one another at a contoured interface 124, which is defined by mutually contacting contoured surfaces of the light-guiding layer 120 and the planarization layer 130.

Diffractive light-turning features 140 are disposed on the contoured interface 124. In some implementations, the contours in the interface 124 define the diffractive light-turning features 140. For example, the diffractive light-turning features 140 can be diffractive gratings defined by steps in the interface 124. The steps may be spaced apart by a distance sufficient to allow the structures 140 to diffract incident light. In some implementations, the diffractive light-turning features 140 occupy about 1% or more, 5% or more, 25% or more, about 50% or more, about 75% or more, or about 90% or more of the total surface area of the interface 124. In some implementations, the surface area of interface 124 occupied by the diffractive light-turning features 140 varies across the light-turning stack 110. In some implementations, the diffractive light-turning features 140 are reflective diffractive light-turning features.

In some implementations, the light-guiding layer 120 functions as a substrate on which the planarization layer 130 can be formed. In some other implementations, the planarization layer 130 functions as a substrate on which the light-guiding layer 120 is formed. In some implementations, the light-guiding layer 120 and the planarization layer 130 mutually fill and occupy the spaces and contours of the respective surfaces of those layers forming the contoured interface 124. For example, the planarization layer 130 occupies or fills the spaces between contours in the light-guiding layer 120, thereby planarizing the light-guiding layer 120 by providing a generally planar surface 132 over the contoured interface 124. Hence, one surface of the planarization layer 130 conforms to the contoured surface of the light-guiding layer 120 at the interface 124 while the opposite surface, the surface 132, is planar. The surface 132 can act as a second major surface for the light-turning stack 110. The planarity of the second major surface 132 facilitates the attachment of other structures or layers to the light-turning stack 110. For example, a display (not shown) may be attached to the second major surface 132.

Typically, equations used to design diffractive light-turning features 140 assume that the contoured surface forming the features 140 is immediately adjacent air. Thus, an air gap may be used to separate the diffractive light-turning features 140 from other layer of materials. It has been recognized, however, that the diffractive light-turning features 140 may be utilized immediately adjacent materials having a refractive index greater than air and that these materials may provide various advantages. By filling in air gaps in the contours of the interface 124, the planarization layer 130 eliminates the air gaps over the contoured surface of the light-guiding layer 120. If present, these air gaps can increase the reflection of light incident on the contoured surface of the interface 124. For example, in front light applications for lighting reflective displays, the light-turning stack 110 is between the display and a viewer, and ambient light incident on the display can be used to illuminate the display. Relatively high reflection of the incident ambient light, such by a surface of the light-guiding layer 120 immediately adjacent air, however, can be detrimental to the contrast ratio of the reflective display. Planarization layer 130, having a surface conforming to the contoured surface of the light-guiding layer 120 at the interface 124, can help to reduce ambient light reflection compared to a configuration in which an air gap was utilized in place of the planarization layer 130. Furthermore, compared to diffractive features immediately adjacent air, the light-turning stack 110 allows for greater control of the diffraction and/or turning characteristics of diffractive light-turning features140 since the index of refraction of both light-guiding layer 120 and planarization layer 130 influence various optical characteristics of the features 140, and these refractive indices can be varied by, for example, the selection of constituent materials. In addition, the height, width, and spacing of surface contours defining the light-turning features 140 may be varied to provide desired light-turning properties.

With continued reference to FIG. 9A, in some implementations, the first major surface 122 is also generally planar and also provides a flat surface that facilitates attachment of the light-guiding layer 120 to other structures, such as layers of material underlying the light-guiding layer 120. In some other implementations, the first major surface 122 may be provided with indentations or protrusions, as desired, to facilitate the integration of the light-guiding layer 120 with structures that may benefit from interfacing with indentations or protrusions. In some implementations, the second major surface 132 may be generally planar. In some other implementations, the second major surface 132 may be generally planar, while also including some indentations or protrusions at some locations, such as the periphery of that surface. Such indentations or protrusions may facilitate the integration of the second major surface 132 with other structures that may benefit from interfacing with indentations or protrusions.

The orientations of the light-guiding layer 120 and the planarization layer 130 can be flipped from that illustrated in FIG. 9A. FIG. 9B shows an example of a cross-section of a light-turning stack that can be used in an illumination device in which the light-guiding layer 120 and the planarization layer 130 of FIG. 9A are flipped. As illustrated, the planarization layer 130 can underlie the light-guiding layer 120. In some implementations, a display (not illustrated) may underlie the planarization layer 130. In such implementations, the diffractive light-turning features 140 can include transmissive light-turning features.

With reference to both FIGS. 9A and 9B, both the light-guiding layer 120 and the planarization layer 130 can be formed of materials that support the propagation of light within those materials. In some embodiments, the both light-guiding layer 120 and planarization layer 130 are optically transmissive or transparent. In some implementations, both light-guiding layer 120 and planarization layer 130 have refractive indices that are greater than air. The planarization layer 130 can have a different refractive index than the light-guiding layer 120. For example, the planarization layer 130 can be formed of a material having a relatively low refractive index relative compared to the refractive index of the material forming the light-guiding layer 120. The refractive index of the planarization layer 130 can be lower than the refractive index of the light-guiding layer 120 by about 0.05 or more, about 0.1 or more, about 0.15 or more, or about 0.2 or more in some implementations.

In some implementations, the planarization layer 130 is formed of a material having a relatively low refractive index, such as polymethylmethacrylate (PMMA, n≠1.49), cyclo-olefin polymer (COP, n≈1.51-1.53) and glass (n≈1.47-1.54), and the light-guiding layer 120 is formed of a material having a relatively high refractive index, such as a nanoparticle-doped epoxy (n≧1.6) or an inorganic optical coating (n≧1.8). In some implementations, the light-guiding layer 120 includes a coating formed onto the planarization layer 130, with the planarization layer 130 serving as a substrate. In some implementations, the light-guiding layer 120 has a thickness of between about 0.1 mm to about 0.5 mm. In other implementations, the light-guiding layer 120 may be a thin coating where a thicker index-matched layer (matched to the light-guiding layer 120) is laminated onto the thin coating. In such implementations, the combination of the coating and the laminated layer together make up a light guide and may have a thickness of between about 0.1 mm to about 0.5 mm. With very small LEDs even thinner light-guide layers 120 or light guides are possible.

In some implementations, the light-guiding layer 120 is formed of a material having a relatively high refractive index, such as cyclo-olefin polymer (COP, n≈1.51-1.53), glass (n≈1.47-1.54), polycarbonate (PC, n≈1.58-1.59), poly(ethylene terephthalate) (PET, n≈1.57-1.58) and poly(ethylene 2,6-naphthalate) (PEN, n≧1.64-1.90) and the planarization layer 130 is formed of a material having a relatively low refractive index, such as a transparent silicones (such as a pressure-sensitive adhesive), amorphous fluoropolymers, aerogels, and other nanoporous materials (including materials having nano-scale air voids). Such relatively low refractive index materials can have a refractive index of less than about 1.50, less than about 1.40, less than about 1.35, or less than about 1.30. In some implementations, the high index of refraction material (forming the light-guiding layer 120) has a high refractive index equal to or greater than about 1.50, and the low index of refraction material (forming the planarization layer 130) has a low index of refraction of less than about 1.50. In some implementations, the high index of refraction is greater than 1.6 and the low index of refraction is equal to or less than 1.52.

In some implementations, materials discussed herein for use in forming the light-guiding layer 120 may be used to form the planarization layer 130, so long as the material forming the planarization layer 130 has a lower refractive index than the material forming the light-guiding layer 120. In addition, in some implementations, materials discussed herein for use in forming the planarization layer 130 may be used to form the light-guiding layer 130, so long as the material forming the light-guiding layer 120 has a higher refractive index than the material forming the planarization layer 130.

The light-guiding layer 120 and planarization layer 130 can be formed of one or more different materials, for example, one or more layers of different material. For example, one or both of the light-guiding layer 120 and planarization layer 130 can be a homogeneous layer of material with the diffractive light-turning structures 140 defined on surfaces of those layers. In some other implementations, one or both of the light-guiding layer 120 and planarization layer 130 can be a multi-part construction and can be formed of multiple sub-layers. In some implementations, the multiple sub-layers are formed of refractive index-matched materials.

FIG. 9C shows an example of a cross-section of the illumination device of FIG. 9B having the light-guiding layer 120 and the planarization layer 130 formed of multiple layers of material. In some implementations, the diffractive light-turning structures 140 can be formed in a film 120a or 130a that is deposited on or attached (for example, by lamination) to a supporting sub-layer 120b or 130b, respectively, with the film 120a or 130a and the supporting sub-layer 120b or 130b together constituting one or both of the light-guiding layer 120 and planarization layer 130. In some implementations, the diffractive light-turning structures 140 are diffractive features in a surface hologram, which is formed in a holographic film before being attached to a supporting sub-layer 120b or 130b to form one of the layers 120 and 130. In some other implementations, the diffractive light-turning features 140 can be diffractive gratings formed in a film before attachment to a supporting sub-layer to form one of the layers 120 and 130.

Formation of the diffractive light-turning features 140 in a separate film can facilitate manufacturing of the diffractive light-turning features 140 by allowing the diffractive light-turning features 140 to be formed in a material that easily supports the manufacture of those features 140. In addition, defective films can be discarded before attachment to a support medium, thereby increasing manufacturing efficiency and minimizing the amount of material that is discarded.

In some implementations where multiple constituent layers form the light-guiding layer 120 or planarization layer 130, the constituent layers forming that particular layer can be index-matched. For example, the constituent layers can have indices of refractive that are within about 0.01 or less, or about 0.005 or less of one another. In some other implementations, an index-matching layer is disposed between neighboring constituent layers to index match those constituent layers by providing a material that has a refractive index that is at a value between the refractive indices of the neighboring layers. In some implementations, the index-matching layer has a refractive index about equal to the square root of the product of the two constituent layers (n_{index-matching layer}=sqrt(n_{constituent layer 1}*n_{constituent layer 2})). As a result, the index-matching layer provides immediately neighboring layers that have a smaller difference (e.g., about 0.01 or less, or about 0.005 or less) in refractive index than the difference that would result if the index-matching layer was not present. Index-matching constituent layers forming, for example, the light-guiding layer 120 allow light to freely propagate through the light-guiding layer 120 substantially without being reflected within that layer, thereby facilitating the use of that layer for propagating and guiding light.

With continued reference to FIGS. 9A-9C, the combination of the light-guiding layer 120 and the planarization layer 130 can provide opposing major surfaces 122 and 132 that are substantially planar. These planar surfaces facilitate the integration and attachment of the light-turning stack 110 with other structures and layers, as discussed herein.

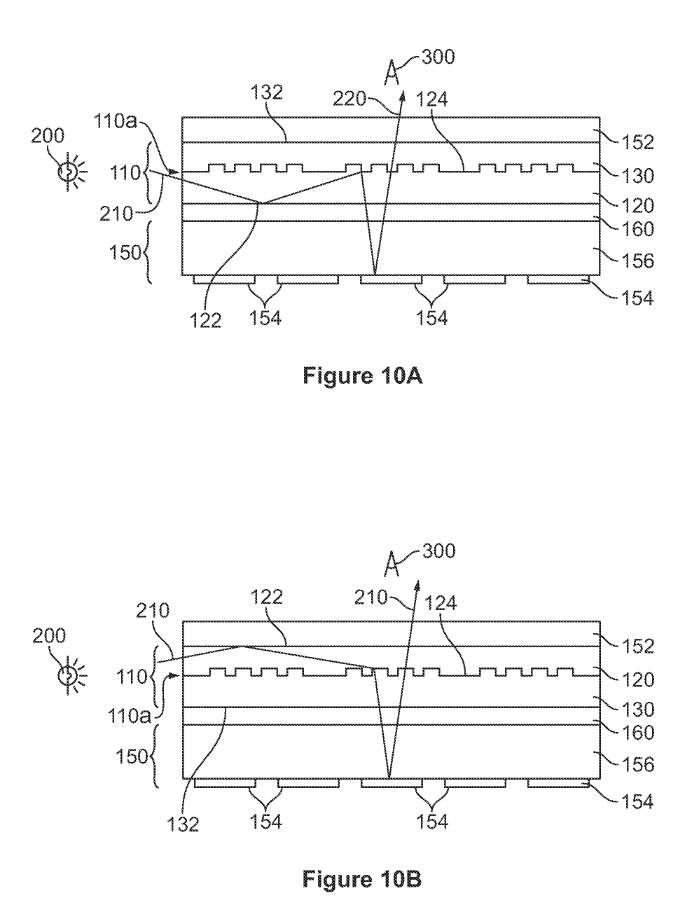

In some implementations, the planar surfaces 122 and 132 allow the light-guiding layer 120 to be integrated in a continuous sequence of layers with other functional layers or structures, including a display. FIG. 10A shows an example of a cross-section of an illumination system for illuminating a display 150. The display 150 can be attached to the planar major surface 122 of the light-guiding layer 120, for example, by an adhesive layer 160. The display 150 can include an array of display elements 154. The display elements 154 can be attached to a support layer 156. The support layer 156 can be, for example, a rigid transparent substrate that provides a mechanically stable base for the display elements 154. In some implementations, the display elements 154 are interferometric modulators that correspond to the interferometric modulators 12 (FIG. 1) and the support layer 156 can correspond to the transparent substrate 20 (FIG. 1).

Opposite the display 150, a functional layer 152 can be attached on and in direct contact with the surface 132 of the light-turning stack 110. In some implementations, the functional layer 152 can perform various functions that are different and in addition to, or that augment the functionality of the light-guiding layer 120. For example, the functions provided by the functional layer 152 can include: antiglare or anti-reflectivity, scratch-resistance, fingerprint or smudge resistance, touch panel functionality, optical filtering, or light diffusion. Thus, the functional layer 152 can be an antiglare layer, a scratch resistant layer, an antifingerprint layer, a touch panel, an optical filtering layer, or a light diffusion layer. In some other implementations, the functional layer 152 can be a combination of these layers. For example, the functional layer 152 can be a single layer of material that performs two or more of the functions noted above, or can be a combination of two or more different layers each performing one function and which together constitute the functional layer 152.

With continued reference to FIG. 10A, the diffractive light-turning structures 140 can be configured to turn light to illuminate the display 150. The illumination system includes a light source 200 configured to inject light into the light-guiding layer 120. The light source 200 can be disposed at a light injection edge 110a of the light-guiding layer 120 and configured to inject light into that edge. The light source 200 may include any suitable light source, for example, an incandescent bulb, a light bar, a light emitting diode (“LED”), a fluorescent lamp, an LED light bar, an array of LEDs, and/or another light source. In some implementations, light from the light source 200 is injected into the light-guiding layer 120 such that a portion of the light propagates in a direction across at least a portion of the light-guiding layer 120 at a low-graze angle relative to the surface of the light-guiding layer 120 aligned with the display 150 such that the light is reflected within the light-guiding layer 120 by total internal reflection (“TIR”).

The light-turning structures 140 in the light-guiding layer 120 redirect or turn light towards display elements 154 in the display 150 at an angle sufficient so that at least some of the light is ejected out of the light-guiding layer 120 to the reflective display 150. Ray 210 shows an example of a light ray that is emitted by the light source 200 and injected into the light-guiding layer 120, that propagates through the light-guiding layer 120 by total internal reflection, contacts the diffractive light-turning features 140 (illustrated as reflective light-turning features), is turned and ejected by the light-turning features 140 out of the light-guiding layer 120 towards the display elements 154, and is then reflected back through the light-turning stack 110 to a viewer 300.

With reference now to FIG. 10B, the positions of the layers 120 and 130 may be flipped. FIG. 10B shows an example of a cross-section of an illumination system in which the layers of the light-turning stack 110 of FIG. 10A are flipped. The light-guiding layer 120 is disposed over the planarization layer 130. In turn, the functional layer 152 is disposed over light-guiding layer 120. On the other side of the light-turning stack 110, the display 150 is disposed under the planarization layer 130. Light ray 210 is injected into the light-turning stack 110 from the light source 200. The ray 210 is ejected from the light-turning stack 110 by the light-turning features 140 towards the display 150, which has display elements 154 that reflect the ray 210 back towards the viewer 300.

With reference to both FIGS. 10A and 10B, as discussed herein, the functional layer 152 may provide various functions, including, without limitation, anti-smudge or anti-reflection functionality. For example, the functional layer 152 may be formed of a material having a low surface energy, for example, about 35 dynes/cm² or less, which allows that layer to act as an anti-smudge layer. In some implementations, the material forming the functional layer 152 is an amorphous fluoropolymer, which provides a low surface energy for antismudge or antifingerprint functionality and can also function as a low reflection layer, with a reflectivity of about 2% or less at an interface of the amorphous fluoropolymer layer with air. In some implementations, the functional layer 152 may have a lower refractive index than the immediately adjacent layer of the light-guiding stack 110, thereby allowing the functional layer 152 to function as a cladding layer that promotes the total internal reflection of light in the light-guiding stack 110. For example, the refractive index of the functional layer 152 may be less than the refractive index of the adjoining part of the light-guiding stack 110 by about 0.05 or more, about 0.1 or more, or about 0.15 or more.

In some implementations, the additional functionality provided by the functional layer 152 may be provided without utilizing that layer 152, by integrating the functionality of that layer with other layers. For example, one or both of the layers 120 and 130 may be formed of a material that provides the desired added functionality. For example, with reference to FIG. 10B, the optically transmissive layer 120 may be formed of a material with a low surface energy (for example, about 35 dynes/cm² or less), which allows the layer to act as an antismudge layer. In some implementations, the planarization layer 130 may function as an antireflection layer in the sense that it causes less reflection than configurations in which an air gap is used in place of the planarization layer 130. For example, one having ordinary skill in the art will understand that typical materials for forming the light-guiding layer 120 can have a reflectivity of about 4% at the interface of the light-guiding layer with air. Providing planarization layer 130 between the light-guiding layer 120 and an air gap can reduce this reflectivity to about 3% or less, or about 2% or less. For example, in some implementations, the material forming the planarization layer 130 is an amorphous fluoropolymer, which provides a low surface energy for antismudge or antifingerprint functionality and can also function as an antireflection layer, with a reflectivity of about 2% or less at an interface of the amorphous fluoropolymer layer with air.

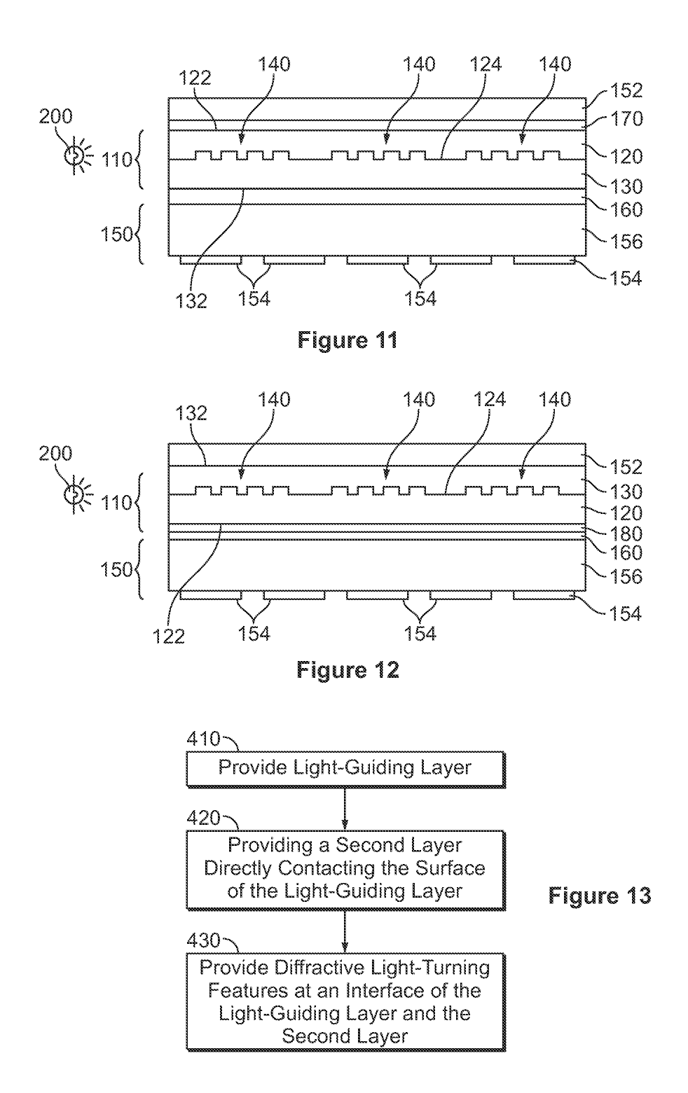

With reference to FIG. 11, various additional layers may be provided to form a structure that extends continuously with the light-turning stack 110. FIG. 11 shows an example of a cross-section of an illumination system having multiple layers formed contacting and directly above and below the light-turning stack 110. In some implementations, one or more additional layers can be disposed over the light-turning stack 110. For example, a first additional functional layer 170 can be provided between the functional layer 152 and the light-turning stack 110. The additional layer 170 can provide various functions. For example, it may be an optical cladding layer that encourages the total internal reflection of light at the interface between the light-guiding layer 120 and the cladding layer, so that the light continues to propagate within the light-guiding layer 120, rather than traveling outside of the layer 120. The cladding layer can have a lower refractive index than the light-guiding layer 120. For example, the refractive index of the cladding layer may be less than the refractive index of the light-guiding layer 120 by about 0.05 or more, about 0.1 or more, or about 0.15 or more.

In some other implementations, one or more additional layers of materials may be disposed underlying the light-turning stack 110. FIG. 12 shows an example of a cross-section of an illumination system in which the layers of the light-turning stack 110 of FIG. 11 are flipped. A second additional functional layer 180 is disposed between the display 150 and the light-turning stack 110. The second additional layer 180 may be a cladding layer to encourage the propagation of light within the light-turning stack 110. The refractive index of the second cladding layer may be at least about 0.05 lower, at least about 0.1 lower, or at least about 0.15 lower, than the refractive index of the part of the light-turning stack 110 immediately adjacent the second cladding layer.

With continued reference to FIGS. 11 and 12, the first and second additional layers 170 and 180 may be provided together, or singly, or not at all in some implementations. For example, where cladding layers for the light-turning stack 110 are desired, the functional layer 152 and/or the adhesive layer 160 may be formed of materials that allow one or both of these layers to function as cladding layers. For example, the functional layer 152 can have a lower refractive index (e.g., about 0.1 lower) than the light-guiding layer 120 of the light-turning stack 110, where the light-guiding layer 120 is immediately adjacent the functional layer 152 or the adhesive layer 160 can have a lower refractive index (e.g., about 0.1 lower) than the light-guiding layer 120, where the adhesive layer 160 is immediately adjacent the light-guiding layer 120. As a result, separate cladding layers may be omitted in some implementations.

With reference to FIG. 13, the optical systems described herein may be formed by various methods. FIG. 13 is a block diagram depicting an example of a method of manufacturing such an optical system. A light-guiding layer is provided 410. A second layer is provided 420 directly contacting the surface of the light-guiding layer. The second layer may be a planarization layer. Diffractive light-turning features are provided 430 at an interface of the light-guiding layer and the second layer. The light-guiding layer and the second layer directly contact each other at the interface. In some implementations, providing the diffractive light-turning features at the interface includes forming the diffractive light-turning features on the light-guiding layer, and providing the second layer includes forming the second layer over the diffractive light-turning features. In some implementations, forming the second layer over the diffractive light-turning features includes extruding the second layer onto the light-guiding layer and the diffractive light-turning features.

In some implementations, providing the diffractive light-turning features can include forming contours at the interface of the light-guiding layer and the second layer and the contours defining the light-turning features. The contours can be formed by removing material from one or both of the light-guiding and second layers. For example, the material removal can be accomplished by a chemical etching process, a mechanical removal/cutting process, a laser cutting process, or a combination thereof. In some implementations the contours can be formed as the light-guiding and/or second layers are formed. For example, the light-guiding layer or second layer may be formed of a material that can be embossed or formed in a mold to define the diffractive light-turning features. In some implementations, one of the light-guiding layer or second layer can function as a mold or a substrate on which the other layer is formed, thereby defining the desired contours in the other layer. For example, contours can be formed in one layer and the other layer can be deposited or coated on that layer, thereby defining the desired contours on surfaces of both layers. Such a deposition can be a bulk deposition followed by a planarization process, or in other implementations, the deposition may be spun-on to form a planar surface opposite the contoured surface. In some implementations, the layer to be coated can be formed by extrusion coating with a nozzle that dispenses a controlled amount of the coating while performing a controlled sweep across the substrate.

In some implementations, as noted herein, the contours can be formed independently of a supporting layer constituting the light-guiding layer or second layer. For example, the contours can be formed in a film, which is then attached to the main body of one of the optically transmissive and second layers.

In some implementations, providing 410 the light-guiding layer may precede providing 420 the second layer. In some other implementations, providing 420 the second layer precedes providing 410 the light-guiding layer. For example, providing the light-guiding layer can include first forming the second layer and then disposing the light-guiding layer on the second layer. Providing the light-guiding layer and second layers on one another can involve depositing one layer directly on the other layer.

In some implementations, a functional layer and/or other structures such as cladding layers and/or display devices can be provided in a continuous sequence of layers with the light-turning stack formed of the light-guiding layer and the second layer. The functional layer and/or other structures can be separately formed and then attached to the light-turning stack, or can be deposited directly on the light-turning stack. Attachment to the light-turning stack can include adhering the functional layer and/or other structures to the light-turning stack using an adhesive layer, or the functional layer and/or other structure can self-adhere to the light-turning stack or other directly neighboring structure.

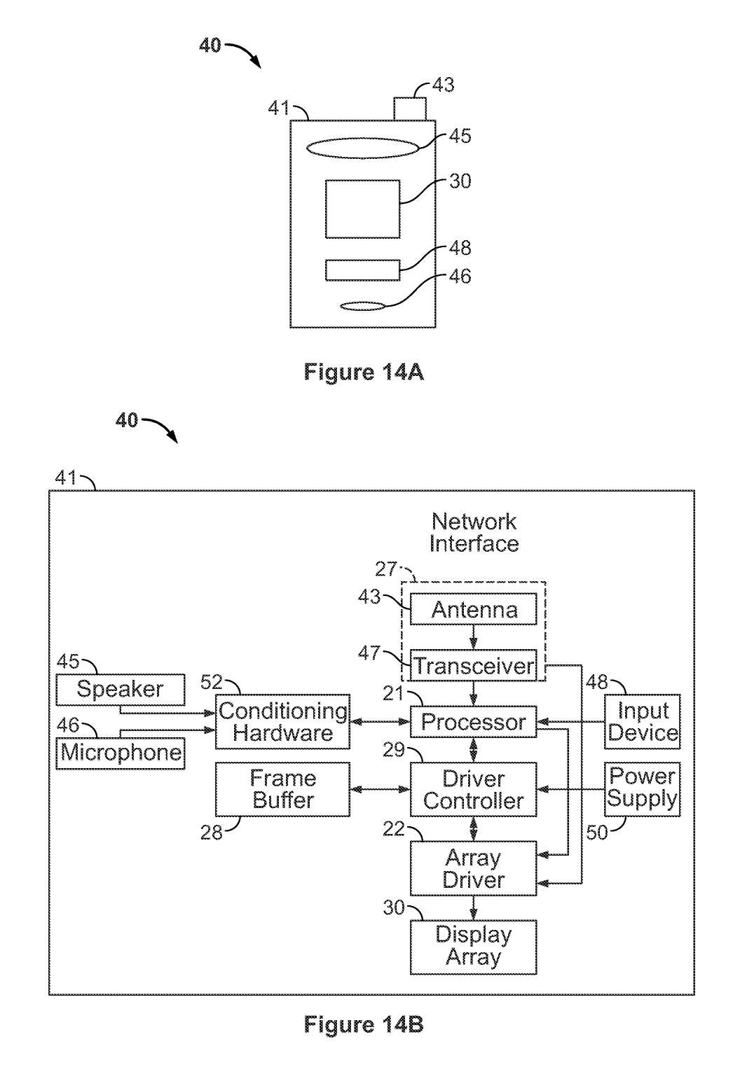

FIGS. 14A and 14B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 (shown in FIGS. 11 and 12 as display 150) may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein. The display 30 may be fabricated using any of the processes and methods disclosed herein. The display 30 may be packaged with an illumination device similar to those disclosed above in reference to FIGS. 9-12 for illuminating the display. In implementations where the display 30 is an interferometric modulator display, the light-turning stack 110 can be part of a front light as shown in FIGS. 11 and 12, or a backlight. More generally, light-turning stack 110 can be part of either a front or backlight.

The components of the display device 40 are schematically illustrated in FIG. 14B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be apparent, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An optical system, comprising:
a first material having a low index of refraction, wherein the low index of refraction is greater than the index of refraction of air;
a second material having a high index of refraction greater than the low index of refraction;
an interface between the first material and the second material; and
diffractive light-turning features formed at the interface.

2. The optical system of claim 1, wherein the second material forms a light-guiding layer.

3. The optical system of claim 2, wherein the high index of refraction is equal to or greater than 1.5 and the low index of refraction is less than 1.5.

4. The optical system of claim 2, wherein the high index of refraction is greater than 1.6 and the low index of refraction is equal to or less than 1.52.

5. The optical system of claim 3, wherein the second material includes one of polycarbonate, poly(ethylene terephthalate), poly(ethylene 2,6-naphthalate), cyclo-olefin polymer, or glass.

6. The optical system of claim 3, wherein the first material includes one of a silicone pressure-sensitive adhesive, an amorphous fluorpolymer, and a nano-porous material.

7. The optical system of claim 2, wherein the second material has an index of refraction of less than 1.5.

8. The optical system of claim 7, wherein the second material is polymethylmethacrylate.

9. The optical system of claim 2, wherein the light guide is configured to propagate light laterally across a length of the light guide, and wherein the diffractive light-turning features are configured to eject the propagating light out of a major surface of the light guide.

10. The optical system of claim 2, wherein the light-guiding layer includes one or more sub-layers of different materials, wherein a layer of the second material constitutes a sub-layer of the light-guiding layer.

11. The optical system of claim 1, wherein the diffractive light-turning features include gratings.

12. The optical system of claim 1, further comprising a functional layer forming a continuous stack of material with a layer formed by the first material and another layer formed by the second material.

13. The optical system of claim 12, wherein the functional layer is immediately adjacent the layer formed by the first material and is selected from the group consisting of an antiglare layer, a scratch resistant layer, an antifingerprint layer, an optical filtering layer, a light diffusion layer, and combinations thereof.

14. The optical system of claim 1, wherein the first and second materials form a light-turning stack, further comprising a light source configured to inject light into the light-turning stack.

15. The optical system of claim 14, further comprising a display, wherein the diffractive light-turning features are configured to eject light out of a major surface of the light-turning stack towards the display.

16. The optical system of claim 15, wherein the display is a reflective display including reflective display elements.

17. The optical system of claim 16, wherein the display elements are interferometric modulators.

18. The optical system of claim 15, further comprising:
a processor that is configured to communicate with the display, the processor being configured to process image data; and
a memory device that is configured to communicate with the processor.

19. The optical system of claim 18, further comprising:
a driver circuit configured to send at least one signal to the display; and
a controller configured to send at least a portion of the image data to the driver circuit.

20. The optical system of claim 18, further comprising:
an image source module configured to send the image data to the processor.

21. The optical system of claim 20, wherein the image source module includes at least one of a receiver, transceiver, and transmitter.

22. The optical system of claim 18, further comprising:
an input device configured to receive input data and to communicate the input data to the processor.

23. An illumination system, comprising:
a means for turning light, including:
a means for guiding light;
a means for providing a planar surface formed on the means for guiding light, the means for providing the planar surface including a material having a different refractive index than the means for guiding light; and
a means for diffractively ejecting light out of the means for guiding light, wherein the means for diffractively ejecting light is formed at an interface of the means for guiding light and the means for providing a planar surface.

24. The illumination system of claim 23, wherein the means for turning light includes a first layer of optically transmissive material, wherein the means for providing the planar surface includes a second layer of optically transmissive material disposed in direct contact with the first layer of the optically transmissive material.

25. The illumination system of claim 24, wherein the means for diffractively ejecting light includes a plurality of spaced-apart diffractive light-turning features.

26. The illumination system of claim 25, wherein the diffractive light-turning features are gratings.

27. The illumination system of claim 23, further comprising a means for providing non-light-guiding functionality in a stack with the means for guiding light and the means for providing the planar surface.

28. The illumination system of claim 27, wherein the means for providing non-light-guiding functionality is a functional layer selected from the group consisting of an antiglare layer, a scratch resistant layer, an antifingerprint layer, an optical filtering layer, a light diffusion layer, and combinations thereof.

29. The illumination system of claim 23, further comprising a light source disposed at an edge of the means for guiding light, the light source configured to inject light into the means for turning light.

30. A method for manufacturing an illumination system, comprising:
providing a light-guiding layer;
providing a second layer having a refractive index that is greater than air and that is different from a refractive index of the light-guiding layer; and
providing diffractive light-turning features at an interface of the light-guiding layer and the second layer, wherein the light-guiding layer and the second layer directly contact each other at the interface.

31. The method of claim 30, wherein providing the light-guiding layer includes first forming the second layer and subsequently disposing the light-guiding layer on the second layer.

32. The method of claim 30, wherein the light-guiding layer includes material having a refractive index greater than 1.5, and the second layer includes material having a refractive index less than 1.5.

33. The method of claim 30, further comprising providing a functional layer in a contiguous stack with the light-guiding layer and the second layer, wherein the functional layer is selected from the group consisting of an antiglare layer, a scratch resistant layer, an antifingerprint layer, an optical filtering layer, a light diffusion layer, and combinations thereof.

34. The method of claim 30, wherein
providing the diffractive light-turning features at the interface includes forming the diffractive light-turning features on the light-guiding layer, and
providing the second layer includes forming the second layer over the diffractive light-turning features.

35. The method of claim 34, wherein forming the second layer over the diffractive light-turning features includes extruding the second layer onto the light-guiding layer and the diffractive light-turning features.
